(19) United States
(12) Patent Application Publication
(10) Pub. No.: US 2015/0217218 A1
(43) Pub. Date: Aug. 6, 2015

(54) FILTER ELEMENT

(71) Applicant: Caterpillar Inc., Peoria, IL (US)

(72) Inventors: Vincent Caliendo, Peoria, IL (US); Jeffrey R. Ries, Metamora, IL (US); Bryant A. Morris, Peoria, IL (US)

(73) Assignee: Caterpillar Inc., Peoria, IL (US)

(21) Appl. No.: 14/172,357

(22) Filed: Feb. 4, 2014

(51) Int. Cl. B01D 35/30

(52) U.S. Cl. CPC B01D 35/306

(57) ABSTRACT

A filter element is disclosed. The filter element includes an angled first end cap and a second end cap, each having angled surfaces. The first and second end caps each include an inner sidewall and an outer sidewall projecting longitudinally from the respective angled surfaces. The outer sidewall is axially spaced apart from the inner sidewall. Further, the inner sidewall defines a centrally disposed through-hole on the respective first and second end caps. The filter element also includes a filter media disposed between the first and second end caps. A first and a second locking mechanism are respectively provided on the first and second end caps. Further, the second locking mechanism of the filter element is configured to abut completely with the first locking mechanism of another filter element.

### TECHNICAL FIELD

The present disclosure relates to a filter system, and more particularly, the filter system including multiple filter elements.

### BACKGROUND

A filter system may include a plurality of filter elements stacked in an end-to-end fashion. In a case wherein two filter elements are configured to be connected to each other, an end surface of one filter element contacts with an end surface of another filter element. These filter elements are then introduced into housing of the filter system. A sealing between each of the plurality of filter elements needs to be accurate so that during working of the filter system, the filter elements do not move relative to each other, as this may affect an overall performance of the filter system. Further, the filter elements may be generally held against each other by a compressive force provided by the housing. Also, geometry of the housing is a key factor for providing the required sealing between each of the plurality of filter elements. Further, the stacking of the filter elements requires geometry of one filter element to conform to the geometry of a subsequent filter element.

U.S. Published Patent Application 2013/0014479 discloses a system, method, and apparatus for providing filtration. According to an example embodiment of the invention, a method is provided for mounting a filter including two or more filter sections in housing. The method can include providing a first filter section configured for mounting to a tube-sheet, the first filter section having a first filter first end and a first filter second end, wherein the first filter second end comprises one or more upper clamp devices; mounting the first filter section with the first filter first end adjacent to the tube-sheet; providing a second filter section having a second filter first end comprising one or more lower clamp devices; and securing the second filter section to the first filter section, wherein the one or more lower clamp devices cooperate with the one or more upper clamp devices to secure the second filter section relative to the first filter section.

### SUMMARY OF THE DISCLOSURE

In one aspect of the present disclosure, a filter element is disclosed. The filter element includes a first end cap. The first end cap is provided at a first end of the filter element. The first end cap has an angled surface. The first end cap includes an inner sidewall projecting longitudinally from the angled surface of the first end cap. The inner sidewall defines a centrally disposed through-hole on the first end cap. The first end cap also includes a first locking mechanism provided on the inner sidewall. The first end cap further includes an outer sidewall spaced apart from the inner sidewall of the first end cap. The outer sidewall of the first end cap projects longitudinally from the angled surface of the first end cap. The filter element also includes a filter media. The filter media is received between the inner and outer sidewalls of the first end cap. The filter element further includes a second end cap provided at a second end of the filter element. The second end cap is connected to the filter media. The second end cap includes an angled surface. The second end cap includes an inner sidewall projecting longitudinally from the angled surface of the second end cap. The inner sidewall of the second end cap defines a centrally disposed through-hole on the second end cap. The second end cap also includes a second locking mechanism provided on the inner sidewall. Further, an outer sidewall is provided in a spaced apart arrangement from the inner sidewall of the second end cap. The outer sidewall projects longitudinally from the angled surface of the second end cap. The second locking mechanism of the filter element is configured to abut completely with the first locking mechanism of another filter element on alignment of the angled surfaces of the second and first end caps respectively.

In another aspect of the present disclosure, a filter system is disclosed. The filter system includes housing. The housing includes an inlet and an outlet. The filter system also includes a filter element provided within the housing. The filter element includes a first end cap. The first end cap is provided at a first end of the filter element. The first end cap has an angled surface. The first end cap includes an inner sidewall projecting longitudinally from the angled surface of the first end cap. The inner sidewall defines a centrally disposed through-hole on the first end cap. The first end cap also includes a first locking mechanism provided on the inner sidewall. The first end cap further includes an outer sidewall spaced apart from the inner sidewall of the first end cap. The outer sidewall of the first end cap projects longitudinally from the angled surface of the first end cap. The filter element also includes a filter media. The filter media is received between the inner and outer sidewalls of the first end cap. The filter element further includes a second end cap provided at a second end of the filter element. The second end cap is connected to the filter media. The second end cap includes an angled surface. The second end cap includes an inner sidewall projecting longitudinally from the angled surface of the second end cap. The inner sidewall of the second end cap defines a centrally disposed through-hole on the second end cap. The second end cap also includes a second locking mechanism provided on the inner sidewall. Further, an outer sidewall is provided in a spaced apart arrangement from the inner sidewall of the second end cap. The outer sidewall projects longitudinally from the angled surface of the second end cap. The second locking mechanism of the filter element is configured to abut completely with the first locking mechanism of another filter element on alignment of the angled surfaces of the second and first end caps respectively.

In yet another embodiment of the present disclosure, a method of assembling a filter system is disclosed. The method includes inserting a first filter element into housing. The method also includes inserting a second filter element into the housing. The method further includes aligning the first filter element with the second filter element at an angled interface defined by a second end cap of the first filter element and first end cap of the second filter element. The method includes locking the first filter element with the second filter element at the angled interface.

Other features and aspects of this disclosure will be apparent from the following description and the accompanying drawings.

### BRIEF DESCRIPTION OF THE DRAWINGS

FIG. 1 is a perspective view of a first filter element of a filter system, according to one embodiment of the present disclosure;

FIG. 2 is a cross-sectional view of the first filter element;

FIG. 3 is a cross-sectional view of the filter system including the first filter element and a second filter element, according to one embodiment of the present disclosure;

FIG. 4 is an exploded view depicting a locking of the first filter element with the second filter element;

FIG. 5 is a cross-sectional view of another configuration of the filter element, according to one embodiment of the present disclosure; and

FIG. 6 is a flowchart for a method of assembling the filter system.

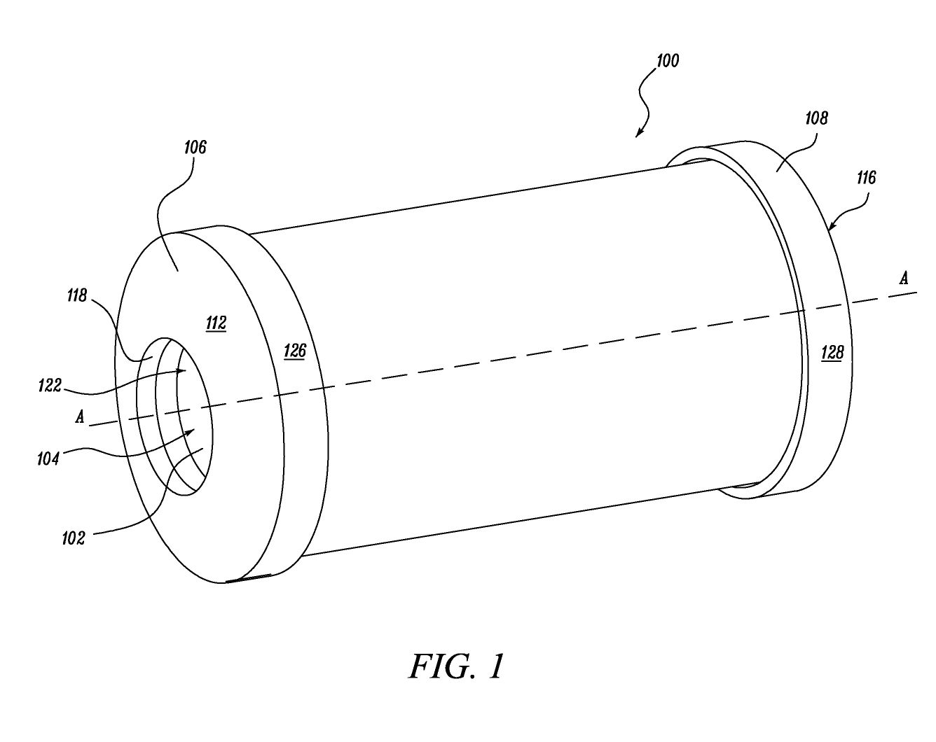

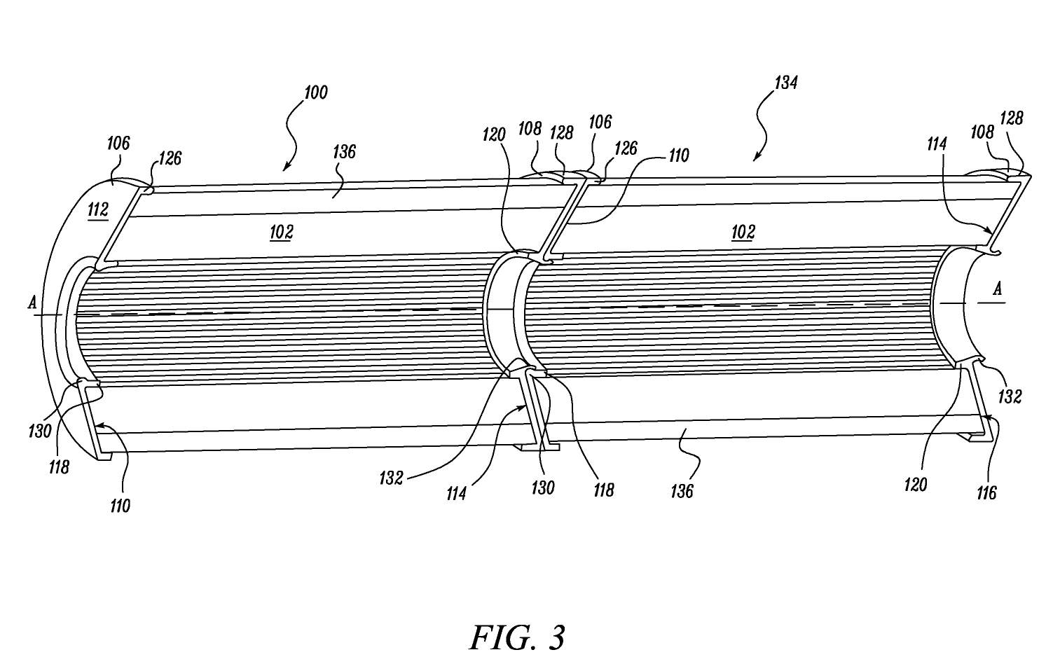

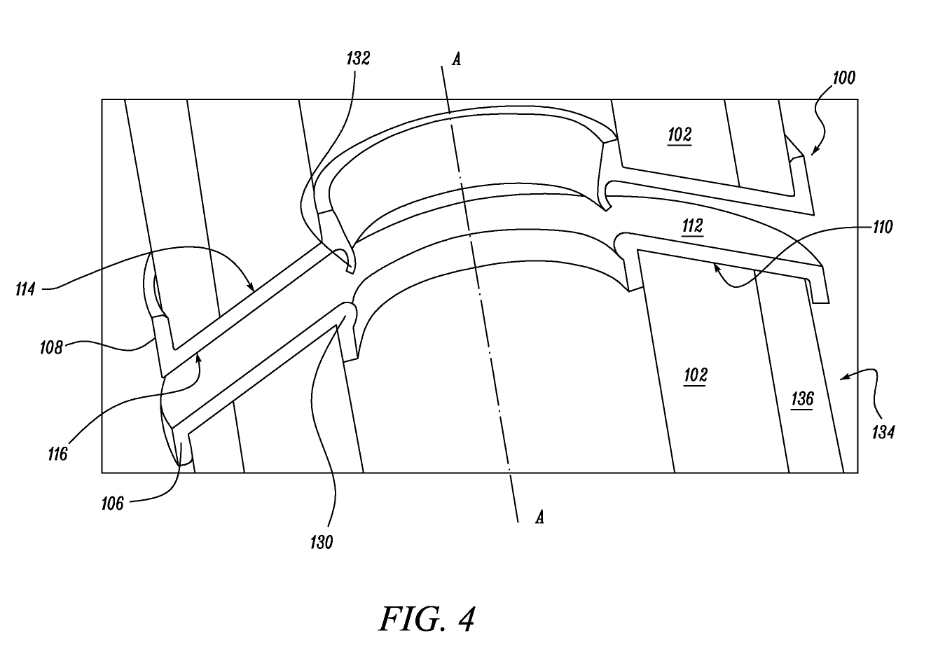

### DETAILED DESCRIPTION

Wherever possible the same reference numbers will be used throughout the drawings to refer to the same or the like parts. FIG. 1 is a perspective view of a filter element 100 (hereinafter interchangeably referred to as a first filter element 100) of a filter system. The filter element 100 defines a longitudinal axis A-A. The filter system may include a plurality of the filter elements 100 provided in an axially-aligned configuration, along the axis A-A (as will be explained in detail in connection with FIGS. 3 and 4).

In one embodiment, the filter system may be associated with a power system (not shown). The power system may include an engine (not shown), such as, a four-stroke compression-ignition engine. One of ordinary skill in the art will appreciate that the engine may be any type of internal combustion engine, for example, a spark-ignition engine, a gasoline engine, a gaseous fuel-powered engine and so on. The power system may include a fuel system (not shown) configured to deliver pressurized fuel into a combustion chamber (not shown) of the engine. During operation of the engine, the fuel entering into the combustion chamber may flow through the filter element 100 of the filter system. The filter element 100 is configured to separate out any contaminants, such as debris or other particulate matter which may be present in the fuel.

In another embodiment, the filter element 100 may be used as an air filter. In this situation, the filter element 100 is configured to separate out the contaminants present in carburetion air. It should be noted that the filter system may be utilized in a variety of applications without any limitation. The environments and applications of the filter system described herein are exemplary and do not limit the scope of the present disclosure.

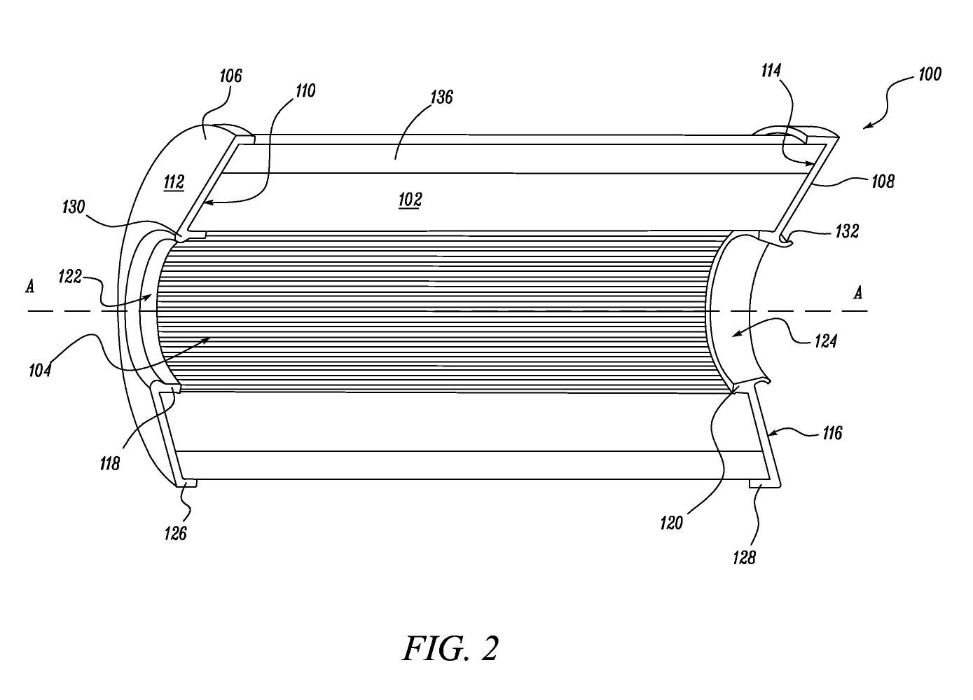

FIGS. 1 and 2 illustrate a perspective view and a cross-sectional view respectively of the filter element 100. The filter element 100 includes a filter media 102 (clearly seen in FIGS. 2 to 4). As shown in accompanying figures, the filter media 102 may have a cylindrical configuration defining a through-hole 104 therein. The filter media 102 may embody a fine mesh of a metal or a polymer.

The filter element 100 includes a first end cap 106 and a second end cap 108 disposed at a first and second end of the filter element 100. Each of the first and second end caps 106, 108 has a disc-shaped configuration. The first end cap 106 has an interior facing side 110 and an exterior facing side 112 with respect to the filter media 102. Similarly, the second end cap 108 includes an interior facing side 114 and an exterior facing side 116. The interior facing side 110, 114 of the first and second end caps 106, 108 is configured to contact with the filter media 102. The first end cap 106 is shaped such that the first end cap 106 has an angled surface. Similarly, the second end cap 108 also has an angled surface.

The angled surfaces of the first and second end caps 106, 108 may conform to each other, such that the angle of the first end cap 106 equals the angle of the second end cap 108. A person of ordinary skill in the art will appreciate that the filter media 102 may be shaped to correspond to the angled surfaces of the first and second end caps 106, 108, so that the filter media 102 may be securely held between the first and second end caps 106, 108 when installed.

The first end cap 106 includes an inner sidewall 118. Further, the second end cap 108 also includes an inner sidewall 120. The inner sidewalls 118, 120 of the first and second end caps 106, 108 projects along the axis A-A defined by the filter element 100. The inner sidewalls 118, 120 project from the interior facing sides 110, 114 of the first and second end caps 106, 108 respectively. The through-holes 122, 124 defined by the first and second caps 106, 108 along with the filter media 102 provide a passage through a length of the filter element 100 for the oil, fuel or air to pass through the filter element 100 for filtration purposes.

The first and second end caps 106, 108 also include an outer sidewall 126, 128 respectively. The outer sidewalls 126, 128 of the first and second end caps 106, 108 are axially spaced apart from the inner sidewalls 118, 120. The outer sidewalls 126, 128 project along the axis A-A, from the interior facing sides 110, 114 of the first and second end caps 106, 108 respectively. The outer sidewalls 126, 128 may be parallel to the inner sidewalls 118, 120, such that the filter media 102 is held between the inner sidewalls 118, 120 and the outer sidewalls 126, 128 of the first and second end caps 106, 108.

Further, the first end cap 106 includes a first locking mechanism provided on the inner sidewall 118. The first locking mechanism is provided on the exterior facing side 112 of the first end cap 106. More specifically, the first locking mechanism includes a first projection 130 extending along the angled surface of the first end cap 106. In one embodiment, the first projection 130 is provided along a periphery of the inner sidewall 118, such that the first projection 130 defines a convex contact area thereon.

The second end cap 108 includes a second locking mechanism. The second locking mechanism includes a second projection 132 provided on the exterior facing side 116 of the second end cap 108. The second projection 132 is configured to define a seat thereon. The seat defines a concave contact area such that the contact area on the first end cap 106 is in conformity with the contact area on the second end cap 108. A combination of the locking mechanisms provided on the angled surfaces of the first and second end caps 106, 108 respectively are configured to allow multiple filter elements 100 to self align and seal against each other in a stack arrangement.

Referring to FIG. 3, is cross sectional view of multiple filter elements 100, namely the first filter element 100 and a second filter element 134, disposed within housing (not shown) of the filter system. It should be noted that the description given above with reference to the filter element 100 applies to both the first and second filter elements 100, 134. The arrangement of the first and second filter elements 100, 134 shown herein is exemplary and does not limit the scope of the present disclosure.

The housing may have a circular cross-section. The housing includes an inlet and an outlet in fluid communication with the first and second filter elements 100, 134. The inlet of the housing may receive the air or the fuel into the filter system. Further, the outlet may provide a passage for the filtered oil, air or fuel to egress from the filter system. In the accompanying figures, the first and second filter elements 100, 134 are arranged such that the first end cap 106 of the first filter element 100 is sealed against the inlet of the housing, whereas the second end cap 108 of the second filter element 134 is sealed against the outlet of the housing.

When the filter system is assembled, the first filter element 100 is configured to seal against the second filter element 134. More particularly, the second locking mechanism provided on the second end cap 108 of the first filter element 100 is configured to abut completely with the first locking mechanism provided on the first end cap 106 of the second filter element 134. FIG. 4 is an exploded view of the first projection 130 of the first end cap 106 being received into the seat defined by the second projection 132 of the second end cap 108 of the second filter element 134, thereby locking or sealing the first filter element 100 with the second filter element 134. Also, the angled surfaces of each of the first and second end caps 106, 108 are aligned with each other when the first filter element 100 is brought in contact with the second filter element 134.

In one embodiment, the filter system may optionally include a tube (not shown) provided within the filter element 100. Further, a lateral wall 136 may be provided surrounding the filter media 102, for holding the filter media 102 within the filter element 100. The lateral wall 136 may connect the outer sidewalls 126, 128 of the first and second end caps 106, 108. The first end cap 106, the second end cap 108 and the lateral walls 136 of the filter element 100 may be made of any material or polymer known in the art.

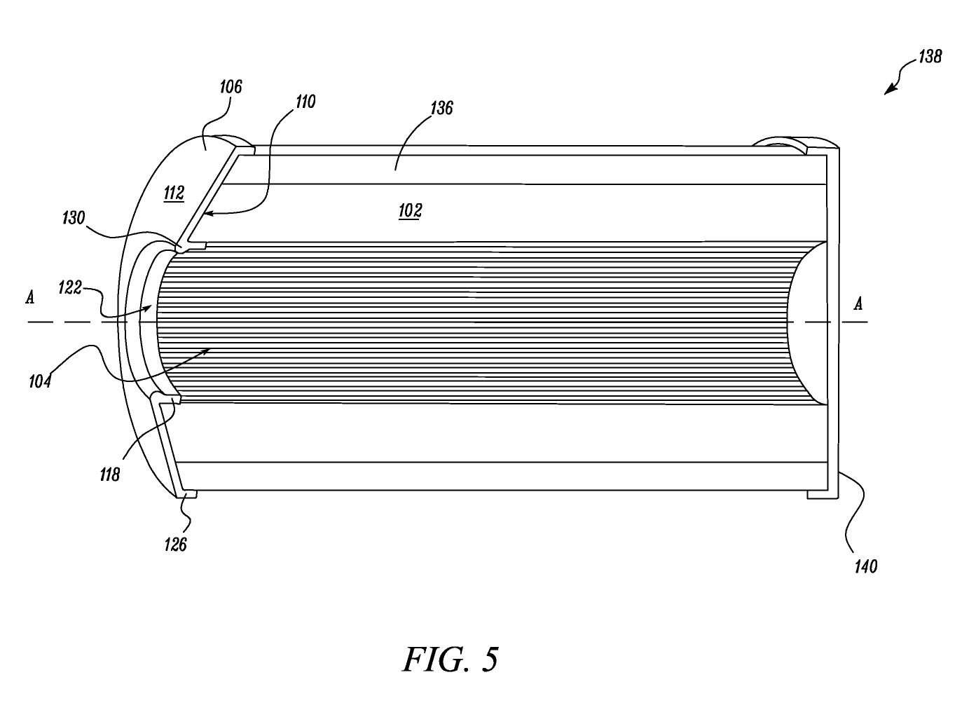

FIG. 5 shows another configuration of the filter element 138, according to some embodiments of the present disclosure. As illustrated, in this configuration the first end cap 106 has the angled surface, whereas the second end cap 140 has a planar configuration and is closed off. The second end cap 140 has a solid disc shaped structure. One of ordinary skill in the art will appreciate that this filter element 138 may be placed as the last filter element in the arrangement of multiple filter elements that are stacked together. As described earlier, the first end cap 106 of the filter element 138 may include the first locking mechanism thereon, such that the filter element 138 may be connected to the second locking mechanism of another filter element 100 connected before it in the arrangement.

### INDUSTRIAL APPLICABILITY

The present disclosure relates to the filter system including the filter elements 100, 134, 138. Each of the filter elements 100, 134, 138 is provided with the first end cap 106 and the second end cap 108, 140 respectively. The design of the first end cap 106 and the second end cap 108, 140 is such that the angled surfaces allow for the first end cap 106 and the second end cap 108, 140 to align with respect to each other when stacked. Further, the first and second locking mechanisms provided on the first end cap 106 and the second end cap 108, 140 respectively facilitate in the sealing of the adjacent filter elements 100, 134, 138. Additionally, the first end cap 106 and the second end cap 108, 140 of the filter elements 100, 134, 138 are shaped such that less support may be required from the housing of the filter system to hold the filter elements 100, 134, 138 therein. The sealing of the filter elements 100, 134, 138 may be achieved by minimal or no compressive forces, wherein a leak proof seal is formed at the angled interface of the first end cap 106 and the second end cap 108, 140.

Further, the disclosed filter elements 100, 134, 138 may provide physical confirmation to service personnel whether the filter elements 100, 134, 138 are installed properly within the housing. For example, when the second filter element 134 is provided within the housing, after inserting the first filter element 100, a clamping sound may be audible to the service personnel, thereby confirming the sealing of the filter elements 100, 134, 138 within the housing. Further, the personnel assembling the first end cap 106 and the second end cap 108, 140 may also feel a physical sensation of the first end cap 106 and the second end cap 108, 140 locking together.

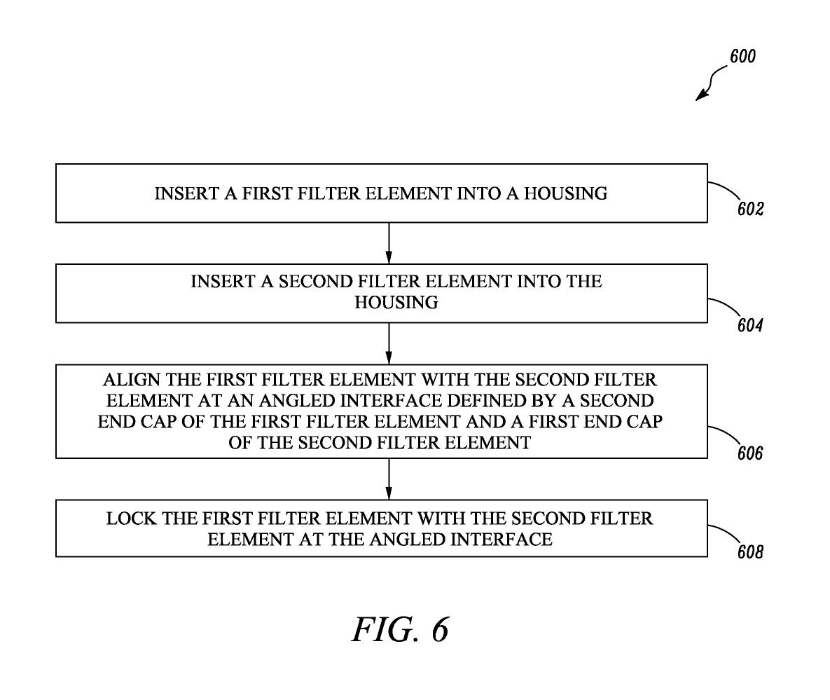

FIG. 6 shows a flowchart for a method 600 of assembling the filter system. At step 602, the first filter element 100 is inserted into the housing. At step 604, the second filter element 134 is inserted within the housing. The second filter element 134 may be pushed into the housing. At step 606, the first filter element 100 is aligned with the second filter element 134. The angled surfaces of the second end cap 108, 140 of the second filter element 134 and the first end cap 106 of the first filter element 100 may contact with each other. The shaping of these surfaces is such that the first and second filter elements 100, 134 may align with each other within the housing.

At step 608, the first filter element 100 is locked with the second filter element 134 at the angled interface defined at the first end cap 106 and the second end cap 108, 140 respectively. The pushing of the second filter element 134 may provide a sealing force for locking the first filter element 100 with the second filter element 134. More specifically, the first projection 130 of the second filter element 134 may be received into the seat defined by the second projection 132 on the first filter element 100 for locking the filter elements 100, 134 with each other.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A filter element comprising:
a first end cap provided at a first end of the filter element, wherein the first end cap has an angled surface, the first end cap comprising:
an inner sidewall projecting longitudinally from the angled surface of the first end cap, the inner sidewall defining a centrally disposed through-hole on the first end cap;
a first locking mechanism provided on the inner sidewall; and
an outer sidewall spaced apart from the inner sidewall of the first end cap, the outer sidewall projecting longitudinally from the angled surface of the first end cap;
a filter media received between the inner and outer sidewalls of the first end cap; and
a second end cap provided at a second end of the filter element, the second end cap connected to the filter media, wherein the second end cap has an angled surface, the second end cap comprising:
an inner sidewall projecting longitudinally from the angled surface of the second end cap, the inner sidewall defining a centrally disposed through-hole on the second end cap;
a second locking mechanism provided on the inner sidewall; and
an outer sidewall spaced apart from the inner sidewall of the second end cap, the outer sidewall projecting longitudinally from the angled surface of the second end cap,
wherein the second locking mechanism of the filter element is configured to abut completely with the first locking mechanism of another filter element on alignment of the angled surfaces of the second and first end caps respectively.

2. The filter element of claim 1, wherein the first locking mechanism includes a first projection provided on an exterior facing side of the first end cap.

3. The filter element of claim 2, wherein the second locking mechanism includes a second projection provided on an exterior facing side of the second end cap, the second projection defining a seat thereon such that the first projection is configured to be received into the seat.

4. The filter element of claim 1, wherein in an arrangement of a plurality of the filter elements, at least one of the first end cap and the second end cap of a last filter element of the arrangement has a closed off and planar configuration.

5. A filter system comprising:
a housing comprising an inlet and an outlet; and
a filter element provided within the housing, the filter element comprising:
a first end cap provided at a first end of the filter element, wherein the first end cap has an angled surface, the first end cap comprising:
an inner sidewall projecting longitudinally from the angled surface of the first end cap, the inner sidewall defining a centrally disposed through-hole on the first end cap;
a first locking mechanism provided on the inner sidewall; and
an outer sidewall spaced apart from the inner sidewall of the first end cap, the outer sidewall projecting longitudinally from the angled surface of the first end cap;
a filter media received between the inner and outer sidewalls of the first end cap; and
a second end cap provided at a second end of the filter element, the second end cap connected to the filter media, wherein the second end cap has an angled surface, the second end cap comprising:
an inner sidewall projecting longitudinally from the angled surface of the second end cap, the inner sidewall defining a centrally disposed through-hole on the second end cap;
a second locking mechanism provided on the inner sidewall; and
an outer sidewall spaced apart from the inner sidewall of the second end cap, the outer sidewall projecting longitudinally from the angled surface of the second end cap,
wherein the second locking mechanism of the filter element is configured to abut completely with the first locking mechanism of another filter element on alignment of the angled surfaces of the second and first end caps respectively.

6. The filter system of claim 5, wherein the first locking mechanism includes a first projection provided on an exterior facing side of the first end cap.

7. The filter system of claim 6, wherein the second locking mechanism includes a second projection provided on an exterior facing side of the second end cap, the second projection defining a seat thereon such that the first projection is configured to be received into the seat.

8. The filter system of claim 5 further comprising:
a tube placed within the through-holes defined by the first and second end caps respectively.

9. The filter system of claim 5 further comprising:
a lateral wall connecting the outer sidewalls of the first and second end caps respectively.

10. The filter system of claim 5, wherein any one of the first end cap and the second end cap is configured to seal against the inlet of the housing.

11. The filter system of claim 5, wherein any one of the first end cap and the second end cap is configured to seal against the outlet of the housing.

12. The filter system of claim 5, wherein in an arrangement of a plurality of the filter elements, at least one of the first end cap and the second end cap of a last filter element of the arrangement has a closed off and planar configuration.

13. A method of assembling a filter system, the method comprising:
inserting a first filter element into a housing;
inserting a second filter element into the housing;
aligning the first filter element with the second filter element at an angled interface defined by a second end cap of the first filter element and a first end cap of the second filter element; and
locking the first filter element with the second filter element at the angled interface.

14. The method of claim 13 further comprising:
connecting the first filter element with an inlet of the housing.

15. The method of claim 13 further comprising:
connecting the second filter element with an outlet of the housing.

16. The method of claim 13, wherein locking the first filter element with the second filter element further comprises engaging a locking mechanism of the first filter element within a seat defined on the second filter element.
